(19) United States
(12) Patent Application Publication
(10) Pub. No.: US 2018/0170701 A1
(43) Pub. Date: Jun. 21, 2018

(54) SHEET CONVEYANCE APPARATUS AND IMAGE FORMING APPARATUS

(71) Applicant: CANON KABUSHIKI KAISHA, Tokyo (JP)

(72) Inventor: Kohei Mizuguchi, Joso-shi (JP)

(21) Appl. No.: 15/832,895

(22) Filed: Dec. 6, 2017

(30) Foreign Application Priority Data
Dec. 16, 2016 (JP) 2016-244807

(51) Int. Cl. B65H 29/14; G03G 15/00

(52) U.S. Cl. CPC B65H 29/14; G03G 15/6529

(57) ABSTRACT

A sheet conveyance apparatus includes a first projected portion including a first contact portion configured to contact against the sheet nipped by the nip portion and arranged on one side with respect to a center-line of conveyance in a width direction, a second projected portion including a second contact portion configured to contact against the sheet nipped by the nip portion and arranged on the other side with respect to the center-line of conveyance in the width direction, and an adjustment mechanism configured to adjust a position of at least either one of the first projected portion and the second projected portion.

### BACKGROUND OF THE INVENTION

### Field of the Invention

The present invention relates to a sheet conveyance apparatus configured to convey sheets, and an image forming apparatus equipped with the same.

### Description of the Related Art

In general, image forming apparatuses adopting an electro-photographic system are configured to fix a toner image transferred onto a sheet by a fixing unit, and discharge the sheet through a sheet discharge roller pair onto a sheet discharge tray. While the sheet is being discharged by the sheet discharge roller pair, especially if the sheet is a thin paper or the like having a low stiffness, the sheet may hang down due to its own weight, and a leading edge of the sheet may collide against the sheet discharge tray, by which stackability of the sheet may be deteriorated.

Japanese Utility Model Laid-Open No. H02-31260 proposes a sheet conveyance mechanism having a stiffness imparting pulley arranged near a sheet discharge roller pair and capable of moving in swinging movement by an arm, and configured to impart stiffness to the sheet by pressing the sheet by a belt wound around the stiffness imparting pulley. According to the sheet conveyance mechanism, position of the belt with respect to the sheet discharge roller pair can be adjusted by pivoting the arm, and amount of stiffness being imparted can be adjusted according to a thickness of the sheet.

Japanese Patent Laid-Open No. 2010-269921 proposes a sheet discharge apparatus that provides a collar having a plurality of grooves on a driving roller of a sheet discharge roller pair, and adjusts an amount of stiffness being imparted to the sheet by the position of ring members fit to the plurality of grooves.

A general image forming apparatus is equipped with a skew correcting portion configured to correct a skew of the sheet that is arranged upstream in a sheet conveyance direction of a transfer portion where the toner image is transferred. However, the amount of skewing correctable by the skew correcting portion is limited, and there were demands for a mechanism that reduces the amount of skewing of the sheet before the sheet is conveyed to the skew correcting portion.

The belt disclosed in the above-described Japanese Utility Model Laid-Open No. H02-31260 configured to impart stiffness to the sheet, and ring members disclosed in the above-described Japanese Patent Laid-Open No. 2010-269921, are provided in multiple numbers and arranged symmetrically with respect to a center-line of conveyance of the sheet in a width direction. Therefore, a conveyance resistance applied to the sheet by the belt or the ring members applied to the sheet was symmetrical in the width direction, and the belt and the ring members did not have a function to correct skew of the sheet.

### SUMMARY OF THE INVENTION

According to a first aspect of the present invention, a sheet conveyance apparatus includes a first projected portion including a first contact portion configured to contact against the sheet nipped by the nip portion and arranged on one side with respect to a center-line of conveyance in a width direction orthogonal to a sheet conveyance direction, the first projected portion being positioned such that the first contact portion protrudes from a first side to a second side with respect to the nip portion in a thickness direction of the sheet, a second projected portion including a second contact portion configured to contact against the sheet nipped by the nip portion and arranged on the other side with respect to the center-line of conveyance in the width direction, the second projected portion being positioned such that the second contact portion protrudes from the first side to the second side with respect to the nip portion in the thickness direction of the sheet, and an adjustment mechanism configured to adjust a position of at least either one of the first projected portion and the second projected portion.

According to a second aspect of the present invention, a sheet conveyance apparatus includes a conveyance portion configured to convey a sheet, a guide member including a guide surface configured to guide the sheet conveyed by the conveyance portion, a resistance member arranged to be projected from the guide surface at one side with respect to a center-line of conveyance in a width direction orthogonal to a sheet conveyance direction, and configured to apply a conveyance resistance to the sheet by contacting against the sheet being conveyed, and an adjustment mechanism configured to adjust at least either one of an amount of projection of the resistance member from the guide surface and a position of the resistance member in the width direction.

Further features of the present invention will become apparent from the following description of exemplary embodiments with reference to the attached drawings.

### BRIEF DESCRIPTION OF THE DRAWINGS

FIG. 1 is an entire schematic drawing illustrating a printer according to a first embodiment.

FIG. 2 is a cross-sectional view illustrating a second sheet discharge portion.

FIG. 3 is a rear side view illustrating a second sheet discharge portion.

FIG. 4 is a perspective view illustrating a stiffness imparting member and a stiffness imparting roller.

FIG. 5 is a perspective view illustrating a stiffness imparting member according to a first modified example of a first embodiment.

FIG. 6 is a perspective view illustrating a stiffness imparting member and a pad member according to a second modified example of the first embodiment.

FIG. 7 is a schematic view illustrating a state in which an image transferred to a sheet is inclined with respect to a sheet conveyance direction.

FIG. 8 is a rear side view illustrating a state in which a position of one of the positioning members is adjusted.

FIG. 9 is an explanatory view illustrating a difference of conveyance resistance applied to the sheet.

FIG. 10 is a schematic view illustrating a state in which the image transferred to the sheet is not inclined with respect to the sheet conveyance direction.

FIG. 11 is an entire schematic drawing illustrating a printer according to a second embodiment.

FIG. 12 is a perspective view illustrating a sheet conveyance apparatus.

FIG. 13 is a perspective view illustrating the sheet conveyance apparatus from a bottom side.

### DESCRIPTION OF THE EMBODIMENTS

### First Embodiment

### General Arrangement

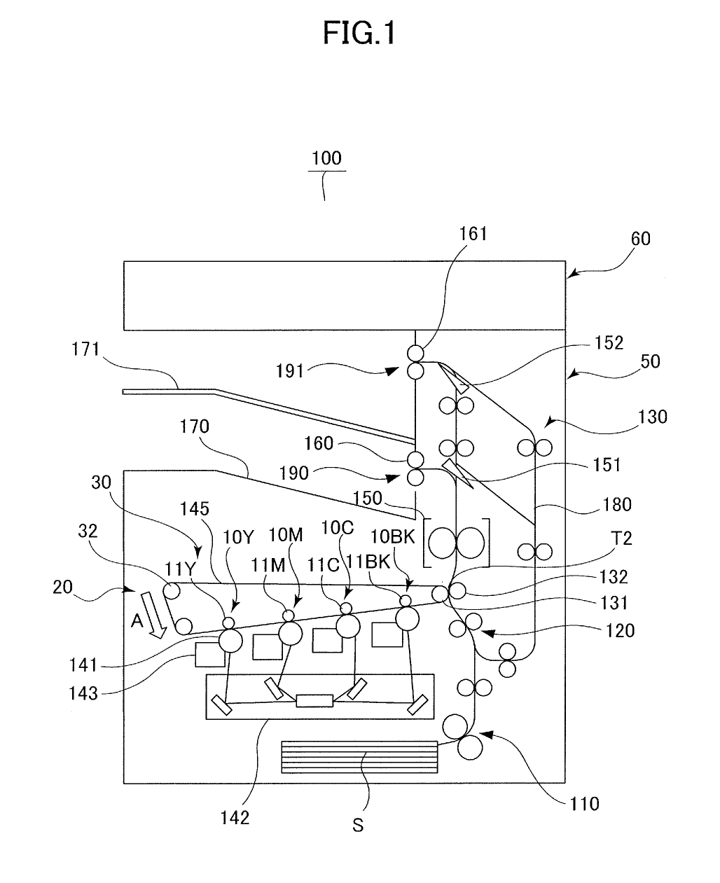

At first, a first embodiment according to the present invention will be described. A printer 100 according to a first embodiment is a laser beam printer adopting an electro-photographic system. The printer 100 serving as an image forming apparatus includes, as illustrated in FIG. 1, a printer body 50 having an image forming unit 20 configured to form an image on a sheet, and a reading apparatus 60 arranged above the printer body 50 and configured to read image data on a document. A sheet discharge space into which a sheet S is discharged is formed between the reading apparatus 60 and the printer body 50, and a lower sheet discharge tray 170 and an upper sheet discharge tray 171 on which discharged sheets S are supported are provided in the sheet discharge space.

The printer body 50 includes a fixing portion 150 configured to fix a toner image transferred to the sheet S by the image forming unit 20, a first sheet discharge portion 190 configured to discharge the sheet S onto the lower sheet discharge tray 170, and a second sheet discharge portion 191 configured to discharge the sheet S onto the upper sheet discharge tray 171. Further, the printer body 50 includes a sheet feeding unit 110 configured to feed the sheet S, a skew correcting portion 120 configured to correct skewing of the sheet S, and a duplex conveyance portion 130 configured to convey the sheet S having images formed on both sides of the sheet.

The image forming unit 20 serving as an image forming means is a so-called four-drum full-color image forming unit including an exposing unit 142, four process cartridges 10Y, 10M, 10C and 10BK, and an intermediate transfer unit 30. The process cartridges 10Y, 10M, 10C and 10BK form toner images of respective colors, which are yellow (Y), magenta (M), cyan (C) and black (BK). The respective process cartridges include a photosensitive drum 141, a developing unit 143, a charging unit and a cleaner not shown.

The intermediate transfer unit 30 includes an intermediate transfer belt 145 wound around a driving roller 131, a tension roller 32 and so on, and the intermediate transfer belt 145 is arranged above the four process cartridges 10Y, 10M, 10C and 10BK. The intermediate transfer belt 145 is arranged to be in contact with respective photosensitive drums of the respective process cartridges, and driven to rotate in a counterclockwise direction, that is, direction of arrow A, by the drive roller 131 driven by a driving unit not shown.

The intermediate transfer unit 30 includes primary transfer rollers 11Y, 11M, 11C and 11BK that abut against an inner circumference surface of the intermediate transfer belt 145 at positions opposed to the respective photosensitive drums. Further, the image forming unit 20 is equipped with a secondary transfer roller 132 abutted against an outer circumference surface of the intermediate transfer belt 145 at a position opposed to the driving roller 131. A secondary transfer portion T2 where a toner image borne on the intermediate transfer belt 145 is transferred to the sheet S is formed as a nip portion between the secondary transfer roller 132 and the intermediate transfer belt 145.

An electrostatic latent image is formed on a surface of the photosensitive drum 141 by the exposing unit 142 in each of the process cartridges 10Y, 10M, 10C and 10BK, and toner is supplied from the developing unit 143, by which toner images of respective colors charged to negative polarity are formed. By applying a transfer bias voltage of positive polarity to the primary transfer rollers 11Y, 11M, 11C and 11BK, the toner images are sequentially transferred in multiple layers to the intermediate transfer belt 145, by which a full-color toner image is formed on the intermediate transfer belt 145.

Simultaneously as the process for forming the toner image, the sheet S fed from the sheet feeding unit 110 is conveyed toward the skew correcting portion 120, and subjected to skew correction by the skew correcting portion 120. The skew correcting portion 120 is composed of a registration roller pair, a register shutter and so on. The skew correcting portion 120 conveys the sheet S to the secondary transfer portion T2 at a matched timing with transfer of the full color toner image formed on the intermediate transfer belt 145. The toner image borne on the intermediate transfer belt 145 is subjected to secondary transfer to the sheet S at the secondary transfer portion T2 by having a transfer bias voltage of positive polarity applied to the secondary transfer roller 132.

The sheet S to which the toner image has been transferred is heated and pressed at the fixing portion 150, and a color image is fixed to the sheet S. The sheet S to which the image has been fixed is guided by a first guide member 151 or a second guide member 152 to the first sheet discharge portion 190 or the second sheet discharge portion 191. The first sheet discharge portion 190 discharges the sheet S through a first sheet discharge roller pair 160 to a lower sheet discharge tray 170. The second sheet discharge portion 191 discharges the sheet S through a second sheet discharge roller pair 161 serving as a conveyance roller pair to the upper sheet discharge tray 171.

In a state where images are to be formed on both sides of the sheet S, the sheet S passes the fixing portion 150, and then guided by the first guide member 151 and the second guide member 152 to the second sheet discharge portion 191. In a state where a trailing edge of the sheet S passes the second guide member 152, the second sheet discharge roller pair 161 is driven to rotate in a reverse direction, and the sheet S is conveyed toward a duplex conveyance path 180. The sheet S conveyed to the duplex conveyance path 180 is conveyed again to the skew correcting portion 120 by the duplex conveyance portion 130 having a plurality of roller pairs, and skewing is corrected by the skew correcting portion 120. Then, image is transferred to a rear side of the sheet S at the secondary transfer portion T2, and the image is fixed by the fixing portion 150, before the sheet S is discharged to the lower sheet discharge tray 170 or the upper sheet discharge tray 171.

### Second Sheet Discharge Portion

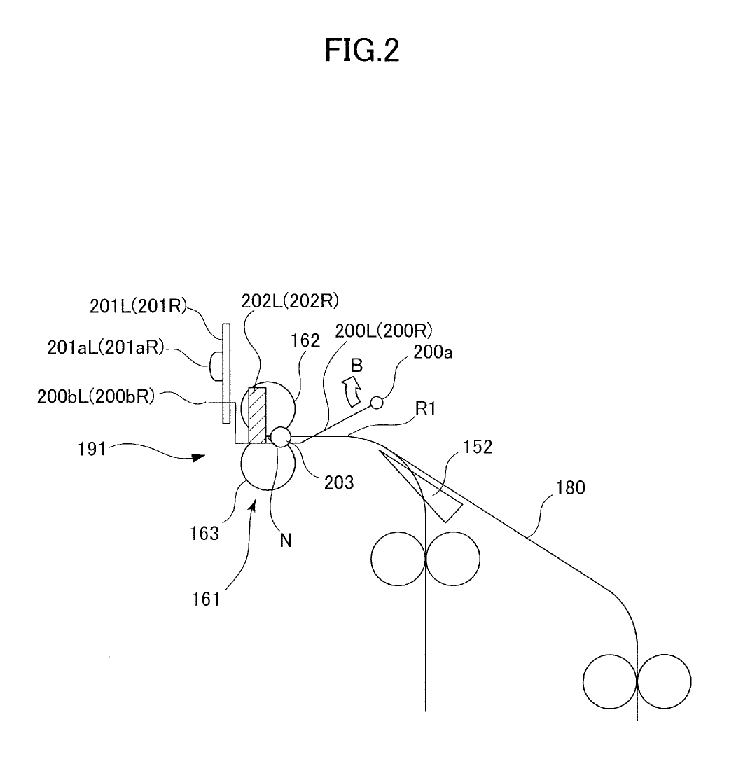

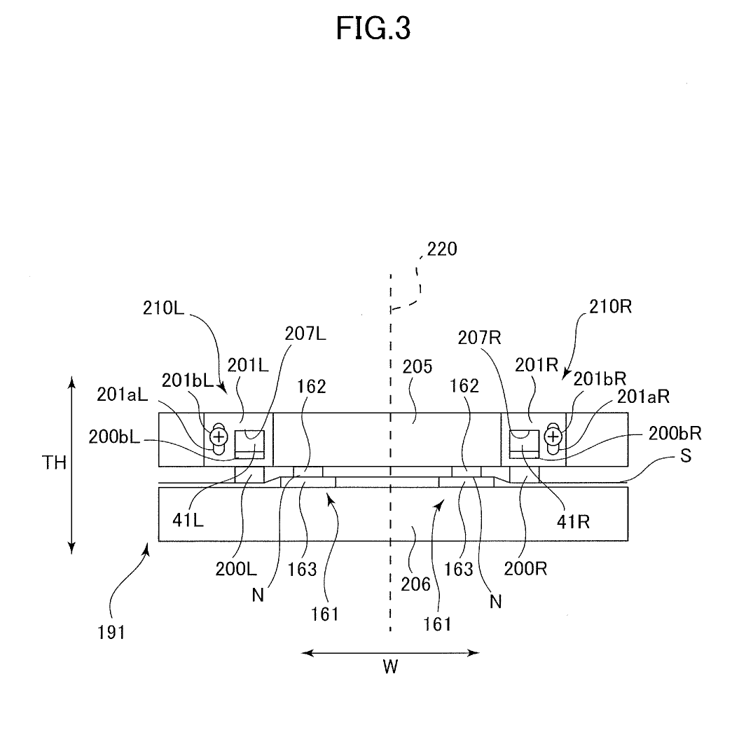

Next, the second sheet discharge portion 191 serving as the sheet conveyance apparatus will be described in detail. The first sheet discharge portion 190 has a similar configuration as the second sheet discharge portion 191, and the description thereof will be omitted. The second sheet discharge portion 191 includes, as illustrated in FIGS. 2 and 3, an upper guide 205 and a lower guide 206 constituting a portion of a sheet discharge conveyance path R1, second sheet discharge roller pairs 161 and 161, stiffness imparting members 200L and 200R, and adjustment mechanisms 210L and 210R.

The second sheet discharge roller pairs 161 and 161, the stiffness imparting members 200L and 200R and the adjustment mechanisms 210L and 210R are arranged symmetrically with respect to a center-line of conveyance 220 in a width direction, i.e., direction of arrow W, orthogonal to the sheet conveyance direction. That is, the stiffness imparting member 200L and the adjustment mechanism 210L are arranged on one side in the width direction with respect to the center-line of conveyance 220, and the stiffness imparting member 200R and the adjustment mechanism 210R are arranged on the other side in the width direction with respect to the center-line of conveyance 220. The second sheet discharge roller pairs 161 and 161 are arranged closer to the center-line of conveyance 220 in the width direction than the stiffness imparting members 200L and 200R.

The second sheet discharge roller pair 161 includes a driving roller 162 supported rotatably by the upper guide 205 serving as a supporting portion, and a driven roller 163 supported rotatably by the lower guide 206. The driven roller 163 is pressed against the driving roller 162 by a spring not shown, and conveys the sheet S by a nip portion N formed together with the driving roller 162. The driving roller 162 can rotate in normal and reverse directions by a motor and a transmission unit configured to transmit the drive of the motor. In a state where the driving roller 162 is rotated in the normal direction, the second sheet discharge roller pair 161 discharges the sheet S to the exterior of the apparatus, and in a state where the driving roller 162 is switched from normal rotation to reverse rotation, the second sheet discharge roller pair 161 can switchback the sheet S.

The stiffness imparting members 200L and 200R are supported pivotably on the upper guide 205 around a pivot fulcrum 200a, as illustrated in FIGS. 2 through 4, and are projected into the sheet discharge conveyance path R1 through each hole 205b formed on a guide surface 205a of the upper guide 205. Stiffness imparting rollers 203 serving as first and second contact portions are provided pivotably at portions protruded through the holes 205b on the stiffness imparting members 200L and 200R, and the stiffness imparting rollers 203 enable the sheet S to be conveyed smoothly.

The adjustment mechanism 210L has a positioning member 201L serving as first and third positioning members, and a long hole 201aL serving as first and third long holes and an engagement hole portion 207L serving as first and third engagement hole portions configured to define an engagement hole 41L serving as a first engagement hole are formed on the positioning member 201L. The long hole 201aL and the engagement hole 41L are extended in a thickness direction, i.e., direction of arrow TH, of the sheet. Further, the adjustment mechanism 210L has a screw 201bL passed through the long hole 201aL, and serving as a first fixing member configured to fix the positioning member 201L in a state where the position of the positioning member 201L is adjusted in the thickness direction with respect to the upper guide 205.

The stiffness imparting member 200L serving as a first projected portion and a first resistance member is urged by a pressurizing spring 202L serving as a first urging portion arranged in a compressed manner between the stiffness imparting member 200L and the upper guide 205 from an upper side toward a lower side with respect to the nip portion N, that is, urged from a first side toward a second side with respect to the nip portion N. A leading edge portion 200bL of the stiffness imparting member 200L is engaged with the engagement hole portion 207L, and positioned in the thickness direction against the urging force of the pressurizing spring 202L. Thereby, the stiffness imparting member 200L and the stiffness imparting roller 203 are positioned in the thickness direction at a position projected from the first side with respect to the nip portion N toward the second side.

Similarly, the adjustment mechanism 210R has a positioning member 201R serving as second and fourth positioning members to which are formed a long hole 201aR serving as second and fourth long holes and an engagement hole portion 207R serving as second and fourth engagement hole portions defining an engagement hole 41R serving as second and fourth engagement holes. The long hole 201aR and the engagement hole 41R are extended in a thickness direction of the sheet, i.e., direction of arrow TH. The adjustment mechanism 210R has a screw 201bR passed through the long hole 201aR, and serving as a second fixing member configured to fix the positioning member 201R in a state where the position of the positioning member 201R in the thickness direction with respect to the upper guide 205 is adjusted. The stiffness imparting member 200R serving as a second projected portion and a second resistance member is urged by a pressurizing spring 202R serving as a second urging portion arranged in a compressed manner between the stiffness imparting member 200R and the upper guide 205 from an upper side toward a lower side with respect to the nip portion N, that is, urged from a first side toward a second side with respect to the nip portion N. A leading edge portion 200bR of the stiffness imparting member 200R is engaged with the engagement hole portion 207R, and positioned in the thickness direction against the urging force of the pressurizing spring 202R. Thereby, the stiffness imparting member 200R and the stiffness imparting roller 203 are positioned in the thickness direction at a position projected from the first side toward the second side with respect to the nip portion N.

The stiffness imparting members 200L and 200R are protruded lower than the nip portion N of the second sheet discharge roller pair 161, and press down the sheet S being nipped by the second sheet discharge roller pairs 161 and 161. Thereby, the sheet S can be bent in the thickness direction to enhance rigidity of the sheet, by which the stackability of the sheet S on the lower sheet discharge tray 170 and the upper sheet discharge tray 171 can be improved. Further, the stiffness imparting members 200L and 200R can abut against or separate from the positioning members 201L and 201R within the range of the engagement holes 41L and 41R. Therefore, in a state where the stiffness imparting members 200L and 200R are pressed by the sheet S, the stiffness imparting members 200L and 200R are pivoted in a direction shown by arrow B of FIG. 2 by the stiffness of the sheet S being conveyed, by which damage of the sheet S can be reduced and jamming of the sheet S can be prevented.

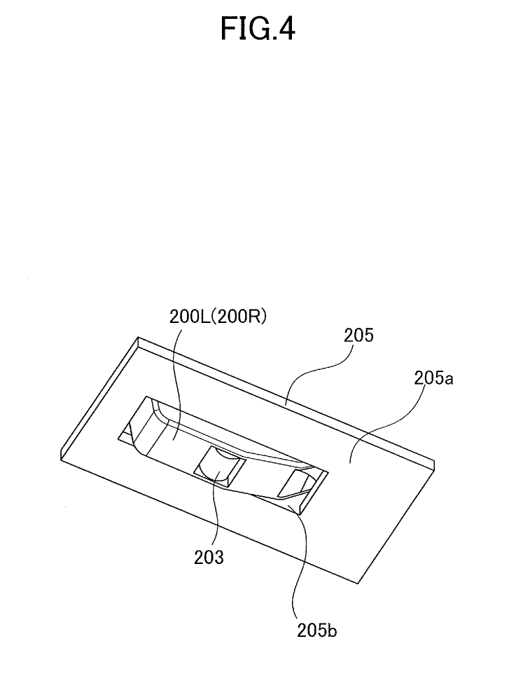

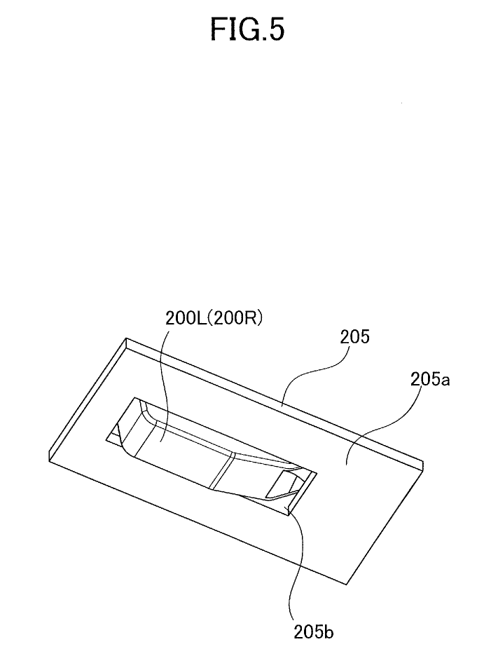

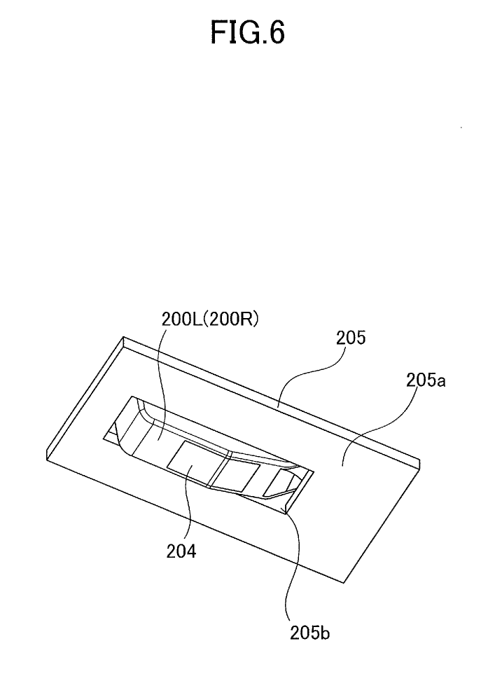

According to the present embodiment, the stiffness imparting roller 203 is provided on each of the stiffness imparting members 200L and 200R, as illustrated in FIG. 4, but the present invention is not restricted to this configuration. For example, the stiffness imparting roller 203 may not be provided, as illustrated in FIG. 5, or a pad member 204 formed of an elastic body can be provided instead of the stiffness imparting roller 203, as illustrated in FIG. 6. Thereby, damage of the sheet can be reduced.

For example, in a large printer having a long conveyance path, there may be a case where the sheet is skewed significantly during conveyance, and the skew cannot be sufficiently corrected by the skew correcting portion 120. In that case, image may be formed in an inclined manner with respect to the direction of the sheet, and image quality may be deteriorated. Especially during duplex printing, the conveyance distance from the skew correction performed by the skew correcting portion 120 to a first side of the sheet to the skew correction performed to a second side of the sheet is long, and many conveyance rollers are arranged along the path, such that amount of skewing of the sheet caused by misalignment and the like of the respective conveyance rollers tends to be significant. Therefore, the present embodiment adopts a configuration where skewing of the sheet S can be corrected in advance to a certain extent by the second sheet discharge portion 191.

### Adjustment of Amount of Imparted Stiffness

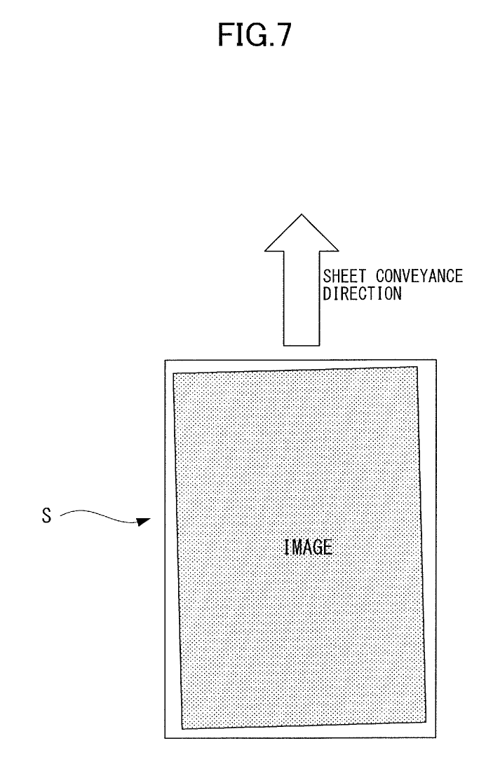

The stiffness imparting members 200L and 200R can independently adjust the amount of stiffness imparted to the sheet S, by changing the position of the positioning members 201L and 201R in the thickness direction. For example, in a state where the image on the second side of the sheet output by a duplex print job is inclined with respect to the sheet conveyance direction, as illustrated in FIG. 7, at least one of the adjustment mechanisms 210L and 210R is adjusted.

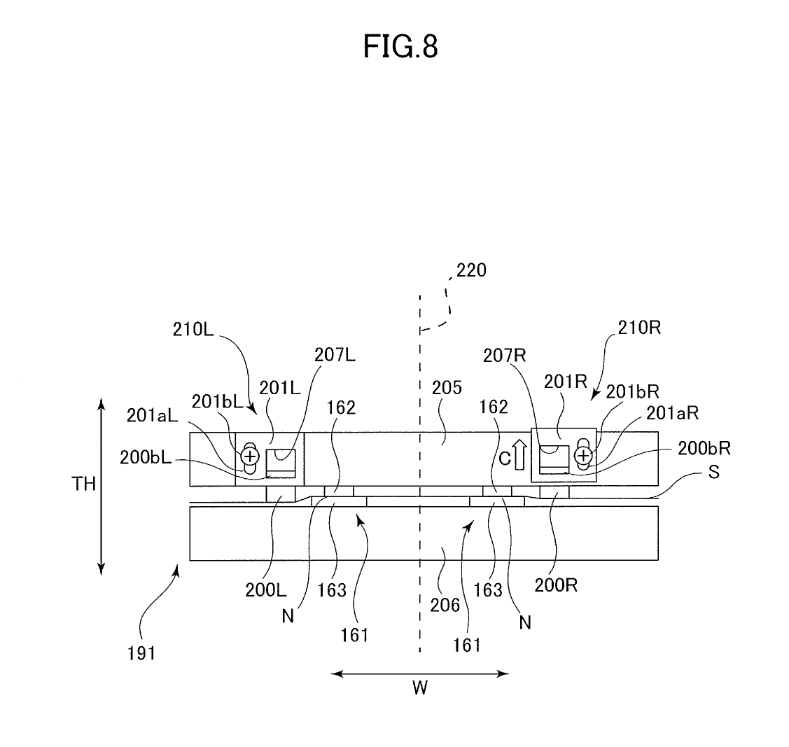

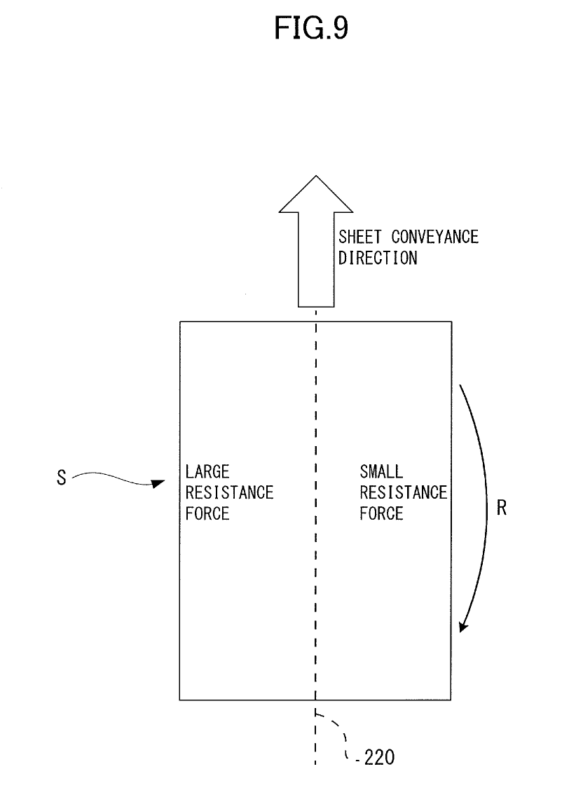

In that case, as illustrated in FIG. 8, the screw 201bR is loosened, the position of the positioning member 201R in the thickness direction is changed along the long hole 201aR toward the direction of arrow C, and the screw 201bR is tightened again. Thereby, the position of the stiffness imparting member 200R is also moved in the direction of arrow C following the positioning member 201R, and the amount of imparted stiffness by the stiffness imparting member 200R, that is, the conveyance resistance applied to the sheet S being conveyed, is reduced. Meanwhile, since the position of the stiffness imparting member 200L is not changed, the conveyance resistance of the sheet S on a first side from the center-line of conveyance 220, i.e., side of the stiffness imparting member 200L, becomes greater than the conveyance resistance of the sheet S on a second side thereof, i.e., side of the stiffness imparting member 200R, as illustrated in FIG. 9. That is, the conveyance resistance of the sheet at least on either the first side or the second side from the center-line of conveyance 220 of the sheet is changed by the adjustment mechanisms 210L and 210R.

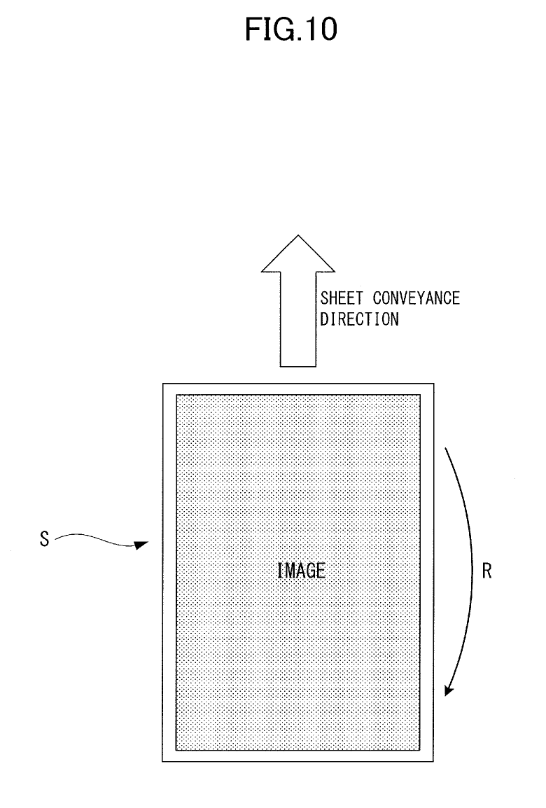

If the sheet S is conveyed in this state, the sheet S will gradually turn toward the direction of arrow R, by which the amount of skewing of the sheet S at the skew correcting portion 120 during image transfer to the second side can be set within a range of amount of skewing correctable by the skew correcting portion 120. As a result, the image formed on the second side of the sheet S becomes advantageous without being skewed with respect to the sheet conveyance direction, as illustrated in FIG. 10.

The timing of performing the adjustment of the amount of stiffness imparted by the stiffness imparting members 200L and 200R may be, for example, during an adjustment step carried out in a production line of a factory, or performed corresponding to individual requests from the users. The method for adjustment involves performing duplex printing once, confirming the inclination of the output image formed on the second side either visually or using a sensor or an imaging device, and performing adjustment of the amount of imparted stiffness as described above according to the amount of inclination of the image. The amount of skewing of the sheet S that occurs during conveyance of the sheet by the duplex conveyance portion 130 is determined, for example, by the alignment of the conveyance roller or the shape of the duplex conveyance path 180, and the tendency of skewing of the sheet S is constant. Therefore, there is no need to adjust the position of the stiffness imparting members 200L and 200R each time the sheet S is conveyed.

Further, in a state where the amounts of imparted stiffness of the respective stiffness imparting members 200L and 200R are adjusted differently from one another, the sheet S will be turned while being conveyed by the second sheet discharge portion 191. However, if the sheet S is discharged onto the upper sheet discharge tray 171 by the second sheet discharge roller pair 161, skewing of the sheet S is not significantly influenced, and especially, the stackability of the sheet S will not be affected.

As described, the present embodiment enables to adjust the amount of imparted stiffness and the conveyance resistance applied to the sheet by the respective stiffness imparting members 200L and 200R in an independent manner. Therefore, even if skewing cannot be sufficiently corrected by the skew correcting portion 120 during duplex printing, skewing of the sheet can be reduced by applying different conveyance resistances to the sheet S by the respective stiffness imparting members 200L and 200R, and a preferable printing image can be acquired.

Moreover, the above-described effects can be acquired by simply adjusting the positions of the positioning members 201L and 201R that adjust the amount of stiffness imparted by the stiffness imparting members 200L and 200R, such that there is no need to provide additional components, and increase of costs can be suppressed.

According to the present embodiment, only the position of the stiffness imparting member 200R between the two stiffness imparting members 200L and 200R is adjusted, but it is also possible to adjust only the position of the stiffness imparting member 200L, or to adjust the positions of both the stiffness imparting members 200L and 200R.

The stiffness imparting members 200L and 200R are supported pivotably on the upper guide 205, but they can also be fixed to the upper guide 205. Further, the stiffness imparting members 200L and 200R can be disposed pivotably on the lower guide 206 and their positions can be made adjustable with respect to the lower guide 206. Moreover, the number of the stiffness imparting members 200L and 200R is not restricted to two, and three or more members can be disposed, considering the size of the sheet S being used.

The positioning members 201L and 201R are respectively fixed by the screws 201bL and 201bR, but they are not restricted to such configuration, and any configuration can be adopted as long as the positions of the stiffness imparting members 200L and 200R are changeable, such as a configuration using a cam to adjust the positions. The positions of the positioning members 201L and 201R do not have to be changed manually, and for example, the positioning members 201L and 201R may be moved through use of a motor, a solenoid, a sensor and so on.

### Second Embodiment

### General Arrangement

Next, a second embodiment of the present invention will be described. In the first embodiment, a configuration has been described in which the stiffness imparting members 200L and 200R apply conveyance resistance that differ in the width direction to the sheet, but according to the second embodiment, the present invention is applied to positions other than the first sheet discharge portion 190 and the second sheet discharge portion 191. Therefore, the configurations similar to the first embodiment are either not shown in the drawing or denoted with the same reference numbers for description.

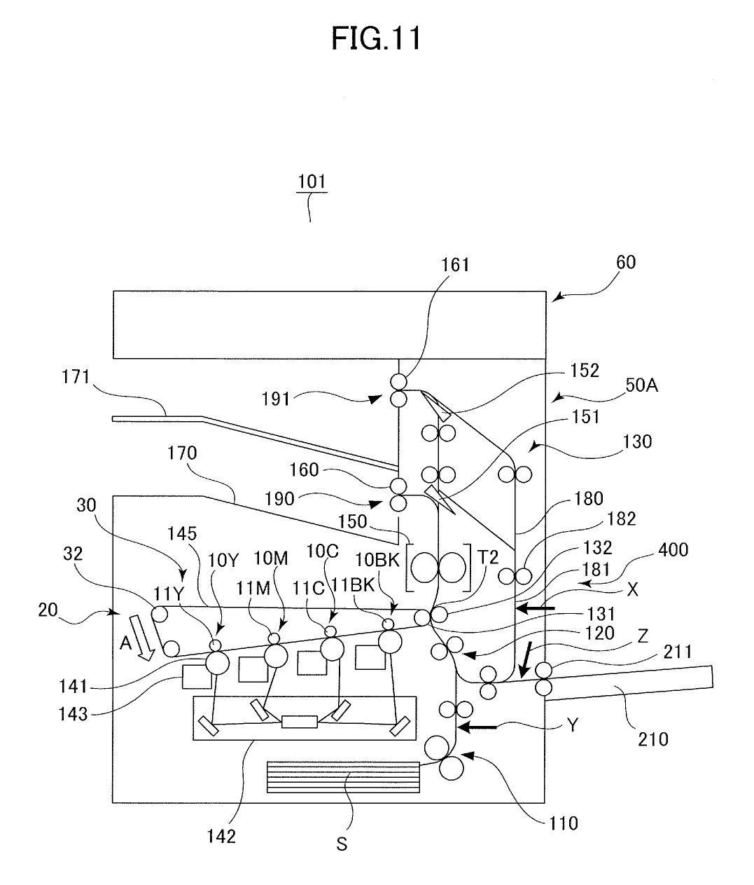

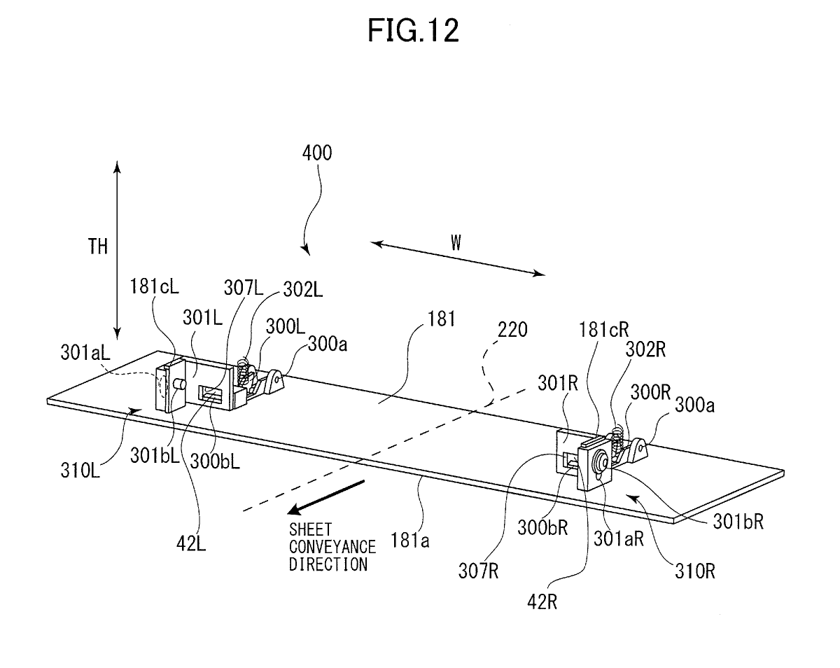

A printer 101 serving as an image forming apparatus includes, as illustrated in FIG. 11, a printer body 50A, and a reading apparatus 60. The printer body 50A includes a manual feed tray 210 and a manual sheet feeding unit 211 configured to feed a sheet supported on the manual feed tray 210. The following describes a case in which a sheet conveyance apparatus 400 (refer to FIG. 12) is arranged at a position of arrow X on the duplex conveyance path 180.

### Sheet Conveyance Apparatus

The sheet conveyance apparatus 400 includes, as illustrated in FIGS. 11 through 13, a conveyance roller pair 182 serving as a conveyance portion, and a guide member 181 having a guide surface 181a configured to guide a sheet conveyed by the conveyance roller pair 182. Further, the sheet conveyance apparatus 400 includes resistance members 300L and 300R capable of applying conveyance resistance to the sheet by abutting against the sheet being conveyed, and adjustment mechanisms 310L and 310R configured to adjust amounts of projection of the resistance members 300L and 300R from the guide surface 181a.

The resistance members 300L and 300R and the adjustment mechanisms 310L and 310R are arranged symmetrically with respect to a center-line of conveyance 220 in a width direction, i.e., direction of arrow W, orthogonal to the sheet conveyance direction. That is, the resistance member 300L and the adjustment mechanism 310L are arranged on a first side in the width direction with respect to the center-line of conveyance 220, and the resistance member 300R and the adjustment mechanism 310R are arranged on a second side in the width direction with respect to the center-line of conveyance 220.

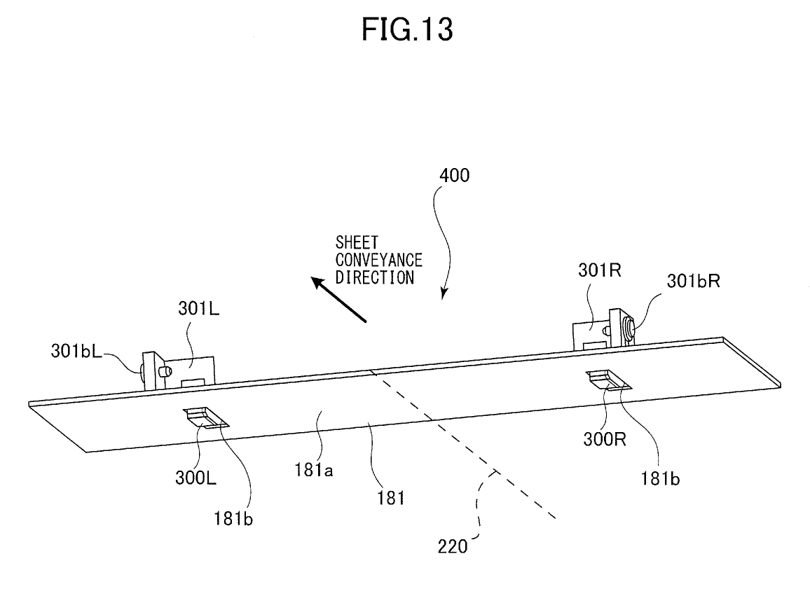

The resistance members 300L and 300R are supported pivotably on the guide member 181 around a pivot fulcrum 300a, as illustrated in FIGS. 12 and 13, and are projected into the duplex conveyance path 180 through each hole 181b formed on the guide surface 181a of the guide member 181.

The adjustment mechanism 310L has a positioning member 301L serving as a third positioning member, and a long hole 301aL serving as a third long hole and an engagement hole portion 307L serving as a third engagement hole portion configured to define an engagement hole 42L serving as a third engagement hole are formed on the positioning member 301L. The long hole 301aL and the engagement hole 42L are extended in a thickness direction of the sheet, i.e., direction of arrow TH. Further, the adjustment mechanism 310L has a screw 301bL passed through the long hole 301aL, and serving as a third fixing member configured to fix the positioning member 301L in a state where the position of the positioning member 301L is adjusted in the thickness direction with respect to a protruded portion 181cL of the guide member 181.

The resistance member 300L serving as a first resistance member is urged by a pressurizing spring 302L serving as a third urging portion toward a direction protruding through the hole 181b into the duplex conveyance path 180. A leading edge portion 300bL of the resistance member 300L is engaged to the engagement hole portion 307L. Thereby, the resistance member 300L is positioned in a state projected through the hole 181b into the duplex conveyance path 180.

Similarly, the adjustment mechanism 310R has a positioning member 301R to which are formed a long hole 301aR and an engagement hole portion 307R defining an engagement hole 42R. The long hole 301aR and the engagement hole 42R are extended in a thickness direction of the sheet, i.e., direction of arrow TH. The adjustment mechanism 310R has a screw 201bR passed through the long hole 301aR, and configured to fix the positioning member 301R in a state where the position of the positioning member 301R is adjusted in the thickness direction with respect to the guide member 181. The resistance member 300R serving as a second resistance member is urged by a pressurizing spring 302R through the hole 181b to a direction projecting into the duplex conveyance path 180. A leading edge portion 300bR of the resistance member 300R is engaged with the engagement hole portion 307R. Thereby, the resistance member 300R is positioned in a state being projected through the hole 181b into the duplex conveyance path 180.

Similar to the first embodiment, the position of the L-shaped positioning members 301L and 301R can be changed in the thickness direction by loosening the screws 301bL and 301bR. Thereby, the amount of projection of the resistance members 300L and 300R from the guide surface 181a can be adjusted, and the conveyance resistances applied to the sheet S by the respective resistance members 300L and 300R can be adjusted independently. By adjusting the conveyance resistances applied to the sheet S by the resistance members 300L and 300R so that they are not symmetric from the center-line of conveyance 220 in the width direction, the amount of skewing of the sheet S can be reduced, and a good print image can be acquired.

The process for correcting skewing of the sheet S during duplex printing has been described, but by arranging the above-described sheet conveyance apparatus 400 at the position shown by arrow Y or arrow Z of FIG. 11, skewing of the sheet S during simplex printing can also be corrected. For example, by arranging the sheet conveyance apparatus 400 at the position of arrow Y, the amount of skewing of the sheet that has occurred from the sheet feeding unit 110 to the skew correcting portion 120 can be suppressed. For example by arranging the sheet conveyance apparatus 400 at the position of arrow Z, the amount of skewing of the sheet that has occurred from the manual sheet feeding unit 211 to the skew correcting portion 120 can be suppressed.

According to the first embodiment, the conveyance resistance applied to the sheet S is adjusted by adjusting the positions of the stiffness imparting members 200L and 200R in the thickness direction, but the present invention is not restricted to this configuration. For example, the conveyance resistance applied to the sheet S can also be adjusted by adjusting the positions of the stiffness imparting members 200L and 200R in the width direction. That is, the adjustment position of the adjustment mechanisms 210L and 210R including the position in the thickness direction with respect to the nip portion N and the position in the width direction from the center-line of conveyance 220 can be adjusted so that they differ between the stiffness imparting rollers 203 of the stiffness imparting member 200L and the stiffness imparting member 200R.

Similarly, according to the second embodiment, the conveyance resistance applied to the sheet S is adjusted by adjusting the amount of projection of the resistance members 300L and 300R from the guide surface 181a, but the present invention is not restricted to this configuration. For example, the conveyance resistance applied to the sheet S can also be adjusted by adjusting the positions of the resistance members 300L and 300R in the width direction. That is, the adjustment mechanism 310L should be configured to be able to adjust at least either the amount of projection of the resistance member 300L from the guide surface 181a or the position of the resistance member 300L in the width direction. The adjustment mechanism 310R should be configured to be able to adjust at least either the amount of projection of the resistance member 300R from the guide surface 181a or the position of the resistance member 300R in the width direction.

According to the first embodiment, long holes 201aL and 201aR are respectively formed on the positioning members 201L and 201R, but it is also possible to form the long holes 201aL and 201aR on the upper guide 205. Further, the engagement hole portions 207L and 207R are respectively formed on the positioning members 201L and 201R, but the present invention is not restricted to this configuration. That is, engagement hole portions can be provided on the stiffness imparting members 200L and 200R, and locking portions capable of being locked to the engagement hole portions on the stiffness imparting members 200L and 200R can be provided on the positioning members 201L and 201R.

Similarly, according to the second embodiment, long holes 301aL and 301aR are respectively formed on the positioning members 301L and 301R, but it is also possible to form the long holes 301aL and 301aR on the protruded portions 181cL and 181cR of the guide member 181. Further, engagement hole portions 307L and 307R are formed respectively on the positioning members 301L and 301R, but the present invention is not restricted thereto. That is, engagement hole portions can be provided on the resistance members 300L and 300R, and locking portions capable of being locked to the engagement hole portions of the resistance members 300L and 300R can be provided on the positioning members 301L and 301R.

According to the embodiments described above, the stiffness imparting members 200L and 200R and the resistance members 300L and 300R are supported pivotably, but the present invention is not restricted to this configuration, and for example, they can be supported slidably in the thickness direction of the sheet, for example.

According further to the embodiments described above, the printer 100 or 101 adopting an electro-photographic system has been described, but the present invention is not restricted to this configuration. For example, the present invention can be applied to an image forming apparatus adopting an ink-jet system in which ink is ejected from a nozzle to form an image on a sheet.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-244807, filed Dec. 16, 2016, which is hereby incorporated by reference wherein in its entirety.

What is claimed is:

1. A sheet conveyance apparatus comprising:
a conveyance roller pair configured to convey a sheet at a nip portion;
a first projected portion comprising a first contact portion configured to contact against the sheet nipped by the nip portion and arranged on one side with respect to a center-line of conveyance in a width direction orthogonal to a sheet conveyance direction, the first projected portion being positioned such that the first contact portion protrudes from a first side to a second side with respect to the nip portion in a thickness direction of the sheet;
a second projected portion comprising a second contact portion configured to contact against the sheet nipped by the nip portion and arranged on the other side with respect to the center-line of conveyance in the width direction, the second projected portion being positioned such that the second contact portion protrudes from the first side to the second side with respect to the nip portion in the thickness direction of the sheet; and
an adjustment mechanism configured to adjust a position of at least either one of the first projected portion and the second projected portion.

2. The sheet conveyance apparatus according to claim 1, further comprising a supporting portion configured to movably support the first projected portion and the second projected portion in the thickness direction,
wherein the adjustment mechanism comprises:
a first positioning member supported movably on the supporting portion and configured to position the first projected portion in the thickness direction; and
a second positioning member supported movably on the supporting portion and configured to position the second projected portion in the thickness direction.

3. The sheet conveyance apparatus according to claim 2, wherein either the supporting portion or the first positioning member defines a first long hole extending in the thickness direction,
either the supporting portion or the second positioning member defines a second long hole extending in the thickness direction, and
the adjustment mechanism comprises:
a first fixing member configured to pass through the first long hole, and fix the first positioning member in a state where a position of the first positioning member is adjusted in the thickness direction with respect to the supporting portion; and
a second fixing member configured to pass through the second long hole, and fix the second positioning member in a state where a position of the second positioning member is adjusted in the thickness direction with respect to the supporting portion.

4. The sheet conveyance apparatus according to claim 2, further comprising:
a first urging portion configured to urge the first projected portion from the first side toward the second side with respect to the nip portion, and
a second urging portion configured to urge the second projected portion from the first side toward the second side with respect to the nip portion,
wherein the first projected portion is configured to contact against and separate from the first positioning member, and is positioned in the thickness direction against an urging force of the first urging portion by contacting against the first positioning member, and
the second projected portion is configured to contact against and separate from the second positioning member, and is positioned in the thickness direction against an urging force of the second urging portion by contacting against the second positioning member.

5. The sheet conveyance apparatus according to claim 4, wherein the first positioning member comprises a first engagement hole portion configured to define a first engagement hole that extends in the thickness direction,
the second positioning member comprises a second engagement hole portion configured to define a second engagement hole that extends in the thickness direction,
the first projected portion is configured to move in the thickness direction within a range of the first engagement hole and positioned by being engaged with the first engagement hole portion, and
the second projected portion is configured to move in the thickness direction within a range of the second engagement hole and positioned by being engaged with the second engagement hole portion.

6. The sheet conveyance apparatus according to claim 2, wherein the first projected portion and the second projected portion are supported pivotably by the supporting portion.

7. The sheet conveyance apparatus according to claim 2, wherein the supporting portion constitutes a portion of a conveyance path through which the sheet is conveyed.

8. The sheet conveyance apparatus according to claim 1, wherein the first projected portion and the second projected portion are arranged symmetrically with respect to the center-line of conveyance.

9. The sheet conveyance apparatus according to claim 1, wherein the first contact portion, the second contact portion and the conveyance roller pair bend the sheet being discharged out of the sheet conveyance apparatus by the conveyance roller pair in the thickness direction.

10. The sheet conveyance apparatus according to claim 1, wherein the conveyance roller pair is configured to discharge the sheet out of the sheet conveyance apparatus by rotating in a normal direction, and configured to switchback the sheet by rotating in a reverse direction.

11. The sheet conveyance apparatus according to claim 1, wherein the adjustment mechanism is configured to adjust a position of at least either one of the first projected portion and the second projected portion in the width direction.

12. A sheet conveyance apparatus comprising:
a conveyance portion configured to convey a sheet;
a guide member comprising a guide surface configured to guide the sheet conveyed by the conveyance portion;
a resistance member arranged to be projected from the guide surface at one side with respect to a center-line of conveyance in a width direction orthogonal to a sheet conveyance direction, and configured to apply a conveyance resistance to the sheet by contacting against the sheet being conveyed; and
an adjustment mechanism configured to adjust at least either one of an amount of projection of the resistance member from the guide surface and a position of the resistance member in the width direction.

13. The sheet conveyance apparatus according to claim 12, wherein the adjustment mechanism comprises a third positioning member supported movably by the guide member and configured to position the resistance member with respect to a thickness direction of the sheet.

14. The sheet conveyance apparatus according to claim 13, wherein one of the guide member and the third positioning member defines a third long hole extending in the thickness direction, and
the adjustment mechanism comprises a third fixing member configured to pass through the third long hole, and fix the third positioning member in a state where a position of the third positioning member is adjusted in the thickness direction with respect to the guide member.

15. The sheet conveyance apparatus according to claim 13, wherein the adjustment mechanism comprises a third urging portion configured to urge the resistance member toward a direction to be projected from the guide surface, and
the resistance member is configured to contact against and separate from the third positioning member, and is positioned in the thickness direction against an urging force of the third urging portion by contacting against the third positioning member.

16. The sheet conveyance apparatus according to claim 15, wherein the third positioning member comprises a third engagement hole portion configured to define a third engagement hole that extends in the thickness direction, and
the resistance member is configured to move in the thickness direction within a range of the third engagement hole and positioned by being engaged with the third engagement hole portion.

17. The sheet conveyance apparatus according to claim 12, wherein the resistance member is a first resistance member,
the adjustment mechanism comprises a second resistance member arranged to be projected from the guide surface at the other side with respect to the center-line of conveyance in the width direction, and configured to apply a conveyance resistance to the sheet by contacting against the sheet being conveyed, and
the adjustment mechanism is configured to adjust at least either an amount of projection of the second resistance member from the guide surface or a position of the second resistance member in the width direction.

18. The sheet conveyance apparatus according to claim 17, wherein the first resistance member and the second resistance member are arranged symmetrically with respect to the center-line of conveyance.

19. The sheet conveyance apparatus according to claim 18, wherein the conveyance portion comprises a conveyance roller pair configured to convey the sheet at a nip portion,
the first resistance member comprises a first contact portion configured to contact against the sheet nipped by the nip portion and arranged on one side with respect to the center-line of conveyance in the width direction, the first resistance member being positioned such that the first contact portion protrudes from a first side to a second side with respect to the nip portion in a thickness direction of the sheet,
the second resistance member comprises a second contact portion configured to contact against the sheet nipped by the nip portion and arranged on one side with respect to the center-line of conveyance in the width direction, the second resistance member being positioned such that the second contact portion protrudes from a first side to a second side with respect to the nip portion in a thickness direction of the sheet, and
the adjustment mechanism configured to adjust a position of at least one of the first resistance member and the second resistance member.

20. An image forming apparatus comprising:
a sheet conveyance apparatus configured to convey a sheet, the sheet conveyance apparatus comprising:
a conveyance roller pair configured to convey the sheet at a nip portion;
a first projected portion comprising a first contact portion configured to contact against the sheet in a state nipped by the nip portion and arranged on one side with respect to a center-line of conveyance in a width direction orthogonal to a sheet conveyance direction, the first projected portion being positioned such that the first contact portion protrudes from a first side to a second side with respect to the nip portion in a thickness direction of the sheet;
a second projected portion comprising a second contact portion configured to contact against the sheet nipped by the nip portion and arranged on the other side with respect to the center-line of conveyance in the width direction, the second projected portion being positioned such that the second contact portion protrudes from the first side to the second side with respect to the nip portion in the thickness direction of the sheet; and
an adjustment mechanism configured to adjust a position of at least either one of the first projected portion and the second projected portion; and
an image forming unit configured to form an image on the sheet conveyed by the sheet conveyance apparatus.

21. An image forming apparatus comprising:
a sheet conveyance apparatus configured to convey a sheet, the sheet conveyance apparatus comprising:
a conveyance portion configured to convey the sheet;
a guide member comprising a guide surface configured to guide the sheet conveyed by the conveyance portion;
a resistance member arranged to be projected from the guide surface at one side with respect to a center-line of conveyance in a width direction orthogonal to a sheet conveyance direction, and configured to apply a conveyance resistance to the sheet by contacting against the sheet being conveyed; and
an adjustment mechanism configured to adjust at least either one of an amount of projection of the resistance member from the guide surface and a position of the resistance member in the width direction; and
an image forming unit configured to form an image on the sheet conveyed by the sheet conveyance apparatus.
